(19) United States
(12) Patent Application Publication
(10) Pub. No.: US 2006/0107560 A1
(43) Pub. Date: May 25, 2006

(54) Motor vehicle information card

(76) Inventor: Willaim Wong, Tempe, AZ (US)

Correspondence Address: The Halvorson Law Firm, 1757 E. Baseline, Ste 130, Gilbert, AZ, 85233, US

(21) Appl. No.: 10/995,767

(22) Filed: Nov. 23, 2004

(51) Int. Cl. G09F 1/00

(52) U.S. Cl. 40/124.01

(57) ABSTRACT

An information card that provide both motor vehicle information and motor vehicle insurance information. This information comprises a copy of the motor vehicle license plate, the motor vehicle year information, make and model informations, color, VIN number, insurance company information, insurance policy number and insurance agent phone number.

### FIELD OF THE INVENTION

The present invention generally relates to information cards. More specifically, the present invention relates to an information card that contains automobile license plate information.

### DESCRIPTION OF THE PRIOR ART

There are frequently times when an owner or user of a motor vehicle may need access to particular information for that motor vehicle. When registering into a hotel, often the registration card requires such information as the license plate number, make, model and year of the motor vehicle. If the motor vehicle has been stolen it is useful to have immediate access to such information as the motor vehicle make, model, year, color, and VIN number. Additionally an actual photograph of the motor vehicle and/or a reproduction of the license plate would be useful for quick recovery of the vehicle.

Further, when in an accident, a quick and convenient means of accessing the motor vehicle insurance information would be useful.

As a result, there is a need for an information card that contains information specific to the user's automobile, automobile license plate, and insurance information.

### SUMMARY OF THE INVENTION

It is an object of the present invention to provide an automobile information card.

It is another object of the present invention to provide an automobile information card that contains information specific to the users automobile license plate(s).

It is yet another object of the present invention to provide an automobile information card that contains information specific to the user's automobile(s).

It is a further object of the present invention to provide an automobile information card that contains information specific to the user's automobile(s) and/or automobile license plate(s).

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments of the invention is not intended to indicate a desire to invoke the special provision of 35 U.S.C. § 112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. § 112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### DESCRIPTION OF THE DRAWINGS

FIG. 1 is a front view of a card according to the present invention illustrating a specific user's license plate.

FIG. 2 is a back view of the same card illustrating the preferred content and placement of motor vehicle information for a specific user's license plate.

FIG. 3 is a front view of a card according to the present invention that illustrates multiple license plates for users with more than one vehicle.

FIG. 4 is a back view of the same multiple vehicle card illustrating the preferred content and placement of multiple motor vehicle information.

### DESCRIPTION OF THE PREFERRED EMBODIMENTS

While the invention is susceptible to various modifications and alternative constructions, the preferred embodiment is shown in the drawings and will be described below in detail. It should be understood, however, that there is no intention to limit the invention to the specific form disclosed, but, on the contrary, the invention is to cover all modifications, alternative constructions, and equivalents falling within the spirit and the scope of the invention as defined in the claims.

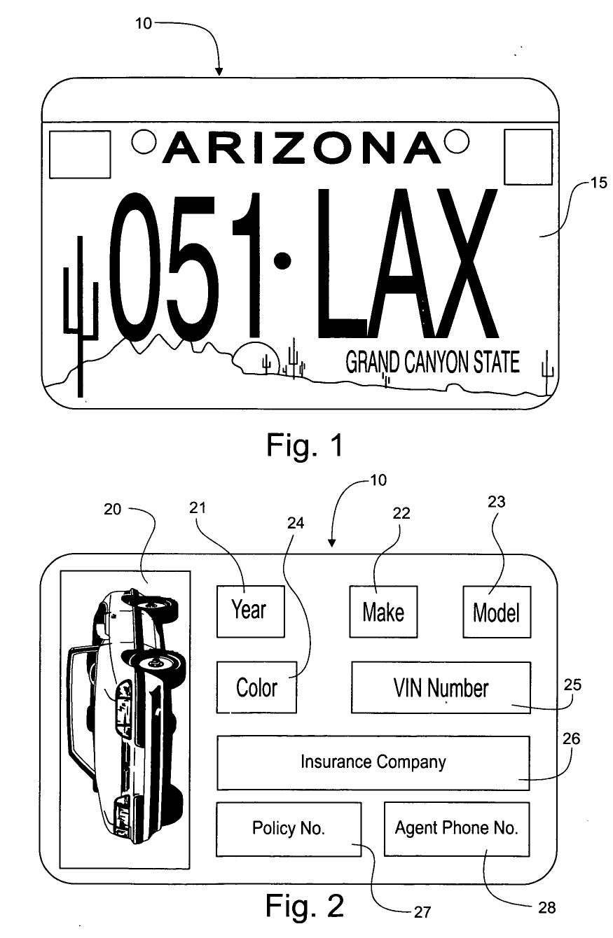

Referring to the figures, the present invention is an information card, generally referred to as 10 that provide both motor vehicle information and motor vehicle insurance information. As can be seen from FIG. 1, the front side of one embodiment illustrates a copy of the owner's license plate 15. Since each state typically has more than one type of license plate background, such as vanity plates, POW plates, Veterans plates, Alternative Fuels plates, and the like, each card would illustrate that same license plate background. Each copy of a license plate would typically contain the state information, license plate number and state slogan.

As can be seen from FIG. 2, a back side of the information card 10 preferably comprises a picture 20 of the motor vehicle that corresponds to the license plate 15. This picture 20 may be either an actual picture of the vehicle or a stock picture, either falls within the scope of the present invention.

Each back side also contains Year information 21, Make information 22, Model information 23, color information 24, VIN Number information 25, Insurance Company information 26, Insurance Policy Number 27, and Insurance Agent Phone Number 28.

In a preferred embodiment the picture 20 is located on one side of the back, preferably the left side as illustrated in FIG. 2. The Year, Make and Model Number informations, 21, 22, and 23, respectively, are located at the top of the back running from left to right. This provides quick reference to the most desired information. The Color and VIN Number information 24 and 25 are located immediately below the Year, Make and Model Number informations, 21, 22, and 23 respectively. This arrangement then places all of the car information together in a single great field located at the top to middle of the back side of the card 10.

Preferably, insurance information is further included on the remaining bottom minor field of the back of the card 10. With the Insurance Company information 26 located near the middle of the back and the Policy Number and Agent Phone Number informations, 27 and 28, respectively, located immediately below that. This arrangement provides quick access to the insurance information in case there is an immediate need.

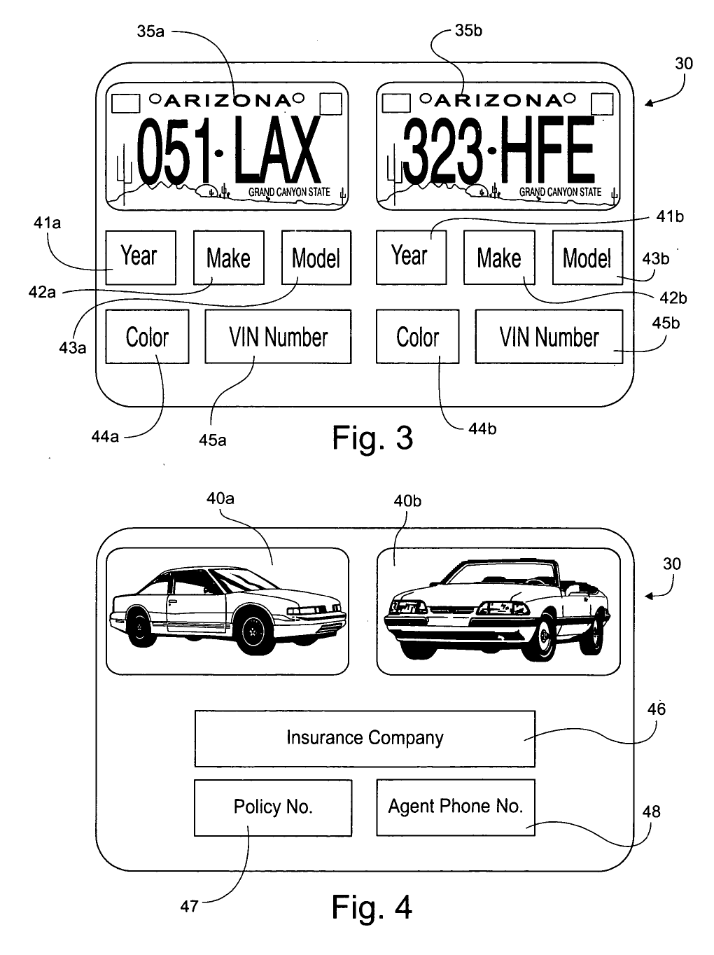

In a second embodiment, illustrated in FIGS. 3 and 4, is a multiple motor vehicle information card 30 according to the present invention that contains information on more than one motor vehicle since many families have multiple motor vehicle. Preferably, the card 30 according to the second embodiment would contain information for two different motor vehicles, with additional motor vehicle information being on separate information cards.

In this second embodiment the front side, illustrated in FIG. 3, comprises a copy of the license plates for two motor vehicles, 35 and 35b. These copies include all of the design and registration information that the actual license plate of the motor vehicle, such as State of registration, license plate number, and State slogan.

Underneath each separate copy of license plates, 35 and 35b, are the Year information 41a, Make information 42a, and Model information 43a. Under this information is the separate motor vehicle Color information 44a and VIN Number information 45a. These different sets of information are preferable side by side as illustrated in FIG. 3. This provides for quick and easy motor vehicle information on each separate vehicle at a single glance.

On the back side of the second embodiment, illustrated in FIG. 4, preferably there are pictures of each separate motor vehicle, 40a and 40b, respectively. As discussed above, these may be actual photographs or stock pictures. Underneath the pictures of the motor vehicles, 40a and 40b, is the insurance company information 46 and underneath the insurance company information 46 is the Policy Number information 47 and the Insurance Agent Phone Number information 48. In the particular embodiment illustrated in FIG. 4, the Insurance policy would be a multiple vehicle policy covering the two motor vehicle shown on the back side.

There is yet another embodiment, less common, where each separate motor vehicle has a different insurance company and/or policy number and/or Insurance Agent. In this embodiment this different information would be located in the same configuration, but just below it's respective picture 40a and 40b.

The information cards 10 and 30 according to the present invention are preferably sized to fit in a standard wallet pocket or picture pouch, similar in size to a credit card or photo ID. Thus, the cards 10 and 30 according to the present invention are convenient to carry around provides for immediate motor vehicle information, even when one is not around the motor vehicle in question.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

We claim:

1. A motor vehicle information card comprising a card having a front side and a back side, the front side comprising a reproduction of a motor vehicle license plate and the back side comprising a picture of the motor vehicle, the motor vehicle year information, the motor vehicle make information, the motor vehicle model information, the motor vehicle color information, the motor vehicle VIN number information, Insurance Company information, Insurance Policy number information and Insurance Agent Phone number information.

2. The motor vehicle information card according to claim 1 wherein the picture of the motor vehicle is located on a side of the back side and is selected from the group consisting of an actual photo of the motor vehicle and a stock photo of the motor vehicle.

3. The motor vehicle information card according to claim 2 wherein the motor vehicle year information, motor vehicle make information and motor vehicle model information is located at a top of the back side.

4. The motor vehicle information card according to claim 3 wherein the motor vehicle color information and motor vehicle VIN number information is located directly beneath the motor vehicle year information, motor vehicle make information and motor vehicle model information.

5. The motor vehicle information card according to claim 4 wherein the Insurance Company information is located directly beneath the motor vehicle color information and motor vehicle VIN Number information.

6. The motor vehicle information card according to claim 5 wherein the Insurance Policy Number and Insurance Agent phone number information are located directly beneath the Insurance Company information.

7. A multiple motor vehicle information card comprising a card having a front side and a back side, the front side comprising at least two reproductions of at least two motor vehicle license plates, at least two motor vehicle year informations, at least two motor vehicle make informations, at least two motor vehicle model informations, at least two motor vehicle color informations, and at least two motor vehicle VIN number informations, and the back side comprising at least two pictures of at least two motor vehicles, at least one Insurance Company information, at least one Insurance Policy number information and at least one Insurance Agent Phone number information.

8. The motor vehicle information card according to claim 7 wherein the at least two pictures of the at least two motor vehicles are located on a side of the back side and are selected from the group consisting of an actual photo of the at least two motor vehicle and a stock photo of the at least two motor vehicle.

9. The motor vehicle information card according to claim 8 wherein the at least two motor vehicle year informations, at least two motor vehicle make informations and at least two motor vehicle model informations are located beneath the at least two reproductions of at least two motor vehicle license plates.

10. The motor vehicle information card according to claim 9 wherein the at least two motor vehicle color informations and at least two motor vehicle VIN number informations are located directly beneath the at least two motor vehicle year informations, at least two motor vehicle make informations and at least two motor vehicle model informations.

11. The motor vehicle information card according to claim 10 wherein the at least one Insurance Company information is located directly beneath the at least two pictures of the at least two motor vehicles.

12. The motor vehicle information card according to claim 11 wherein the at least one Insurance Policy Number and at least one Insurance Agent phone number information are located directly beneath the at least one Insurance Company information.
